(19) United States
(12) Patent Application Publication
(10) Pub. No.: US 2026/0201897 A1
(43) Pub. Date: Jul. 16, 2026

(54) HYDRAULIC COMPENSATION DEVICE

(71) Applicant: SAFRAN AIRCRAFT ENGINES, PARIS (FR)

(72) Inventors: BRUNO ALEXANDRE DIDIER JACON, MOISSY-CRAMAYEL (FR); CÉDRIC ANTONIO DA SILVA, MOISSY-CRAMAYEL (FR); TIMOTHÉE JEAN MARIE LALOY, MOISSY-CRAMAYEL (FR); GEOFFRAY FERNAND JACQUES DETERRE, MOISSY-CRAMAYEL (FR); MOUHSINE AABI, MOISSY-CRAMAYEL (FR)

(21) Appl. No.: 19/135,113

(22) PCT Filed: Nov. 17, 2023
(86) PCT No.: PCT/FR2023/051817

§ 371 Date: Jun. 3, 2025

(30) Foreign Application Priority Data
Dec. 16, 2022 (FR) FR2213603

(51) Int. Cl. F04D 29/063; F04D 29/32

(52) U.S. Cl. CPC F04D 29/063; F04D 29/321; F05D 2220/323; F05D 2220/36; F05D 2260/98

(57) ABSTRACT

A hydraulic compensation device for placement in a cavity for circulating a lubricant of a bladed propeller rotor in a turbomachine, the rotor having an axis (X), wherein the compensation device comprises an annular part and a piston, the annular part having a groove that forms a track in which the piston can slide between at least a starting position and a retracted position.

### FIELD OF THE INVENTION

The present invention relates to the field of turbomachines and relates more particularly to turbomachines of the non-faired type.

More particularly, the invention relates to a hydraulic compensation device intended to be arranged in a cavity for a lubricant of a bladed propeller rotor of a turbomachine having an axis.

The invention relates to all the types of aircraft turbomachine, in particular turbojet engines and turboprop engines having a bladed propeller.

### PRIOR ART

Turbomachine bladed propeller rotors conventionally comprise, for each blade, a blade trunnion mobile in rotation about an axis perpendicular to the axis of the turbomachine, and a hub arranged around the blade trunnion.

Propeller blade trunnions are guided in rotation via bearings which need to be constantly lubricated at the contact surface between the rolling element and the race so that their operation is not impaired. Therefore, a lubricant is generally implemented in the cavity defined by the hub and the blade trunnion and opening onto the bearings. So that the bearings are lubricated constantly and thus so as to ensure a thin layer of lubricant between the rolling element and the bearing rings, it is necessary for the cavity to be almost completely or completely filled with this lubricant so that the bearing is always lubricated during all the rotations of the blade.

However, during the flight phases, and in particular at take-off, the temperatures in the cavity can reach a hundred degrees, and thus result in an increase in pressure linked to the expansion of the lubricant, for example oil, of approximately 11.25 bar per degree Celsius. If the expansion of the lubricant is not contained during the flight phases, then the internal pressure in the cavities can reach several hundred bars of pressure, which can cause damage to the seals as well as to the surrounding parts such as the hub of the propeller.

In order to limit the increase in the internal pressure of the system, it is thus known to implement hydraulic compensation devices, in particular taking the form of an expansion tank. Several expansion tank systems are generally used, with an expansion tank implementing a deformable elastomer membrane, or an expansion tank implementing a piston as for example described in the document FR2498278.

In the case of an elastomer membrane, the disadvantage is that this requires in particular having an elastomer compatible with the operating temperatures and the nature of the lubricant, and imposes ensuring a certain static sealing at the retaining of the membrane. In addition, this solution adds an additional element which can have an impact on the ease of implementation and on the capacity for integration into aerospace uses, but also a mass impact, in particular at a propeller rotor.

Another problem of the current solutions is that the current hydraulic compensation devices are implemented in the form of an external expansion tank and therefore require the addition of additional means. Furthermore, it is relatively difficult to integrate such external solutions into aeronautical uses, and in particular at propeller rotors, the performance of which also depends on the balancing when correcting imbalances, without disturbing the proper operation of such complex aeronautical systems.

There is therefore a need to provide a solution allowing to ensure the lubrication of the propeller rotor while compensating for the pressure increases due to the increase in the temperature during the operation of turbomachines.

### DISCLOSURE OF THE INVENTION

The goal of the invention is to at least partly overcome the disadvantages mentioned above relating to the techniques of the prior art.

To do this, the invention relates to a hydraulic compensation device intended to be arranged in a cavity for circulation of a lubricant of a bladed propeller rotor of a turbomachine having an axis X. According to the invention, the device comprises an annular body and a piston, said annular body having a groove forming a track in which said piston is capable of sliding between at least an initial position and a retracted position.

Thus, the invention proposes a novel and inventive approach allowing to at least partly resolve some of the disadvantages of the prior art.

In particular, such an invention allows to ensure the lubrication of the propeller rotor while compensating for the pressure increases due to the increase in the temperature during the operation of the turbomachines. Indeed, the space occupied by the hydraulic compensation device allows to place a smaller amount of lubricant, while continuing to fill the cavity completely with oil, and thus to limit its expansion, while ensuring permanent contact between the lubricant and the bearings.

Furthermore, the integration of such a solution is relatively simple, without disrupting the proper operation of such complex aeronautical systems.

According to a specific aspect of at least one embodiment of the invention, the hydraulic compensation device comprises at least one return spring arranged between said annular body and said piston and configured to exert a return force on said piston so as to return it towards said initial position.

Preferably the return force on said piston so as to return it towards said initial position can be exerted during the phases of engine stoppage.

According to a specific aspect of at least one embodiment of the invention, the hydraulic compensation device further comprises a bearing washer arranged between the at least one return spring and said piston.

Such a bearing washer thus allows to have bearing between the at least one bearing spring and the piston while limiting the deformations of the piston, in particular at the zones of contact with the return spring(s).

According to a specific aspect of at least one embodiment of the invention, said bearing washer is made at least partially from a metal or from a metal alloy, or from a preferably composite plastic.

According to a specific aspect of at least one embodiment of the invention, said annular body is made at least partially from a metal, a metal alloy, or a plastic.

According to a specific aspect of at least one embodiment of the invention, said piston is made at least partially from virgin PTFE, filled PTFE, or an elastomer.

It should be noted that the piston can also comprise metal energizing springs.

The advantage of such a material is that the piston can also itself act as a sealing joint.

The invention also relates to a bladed propeller rotor of a turbomachine having an axis X, comprising a blade trunnion mobile in rotation about an axis Y perpendicular to said axis X of the turbomachine, and a hub arranged around said trunnion, said hub and said blade trunnion defining a cavity for circulation of a lubricant. According to the invention, said rotor further comprises a hydraulic compensation device according to one of the aforementioned embodiments, said hydraulic compensation device being mounted in said cavity.

According to a specific aspect of at least one embodiment of the invention, said piston is capable of sliding in said annular body along said axis Y.

According to a specific aspect of at least one embodiment of the invention, said hydraulic compensation device is fastened to said propeller rotor via said annular body fastened against an inner wall of said hub.

The invention also relates to a bladed propeller, comprising a rotor according to one of the aforementioned embodiments.

The invention also relates to an aircraft turbomachine, comprising at least one bladed propeller.

According to a specific aspect of at least one embodiment, the turbine is a turbojet engine.

### PRESENTATION OF THE DRAWINGS

The invention, as well as the various advantages it has, will be more easily understood in the light of the following description of an illustrative and non-limiting embodiment thereof, and the appended drawings among which:

FIG. 1 is a schematic cross-sectional view of a turbomachine;

FIG. 2 is a simplified schematic cross-sectional view of a bladed propeller rotor according to an embodiment of the invention, without the hydraulic compensation device;

FIG. 3 is a simplified schematic cross-sectional view of the bladed propeller rotor of FIG. 2, with the hydraulic compensation device;

FIG. 4 is a schematic cross-sectional view of the hydraulic compensation device of FIG. 3;

FIG. 5 is an exploded perspective view of the hydraulic compensation device of FIG. 3, and

FIG. 6 is a perspective view of the hydraulic compensation device of FIG. 3.

### DETAILED DESCRIPTION OF AN EMBODIMENT OF THE INVENTION

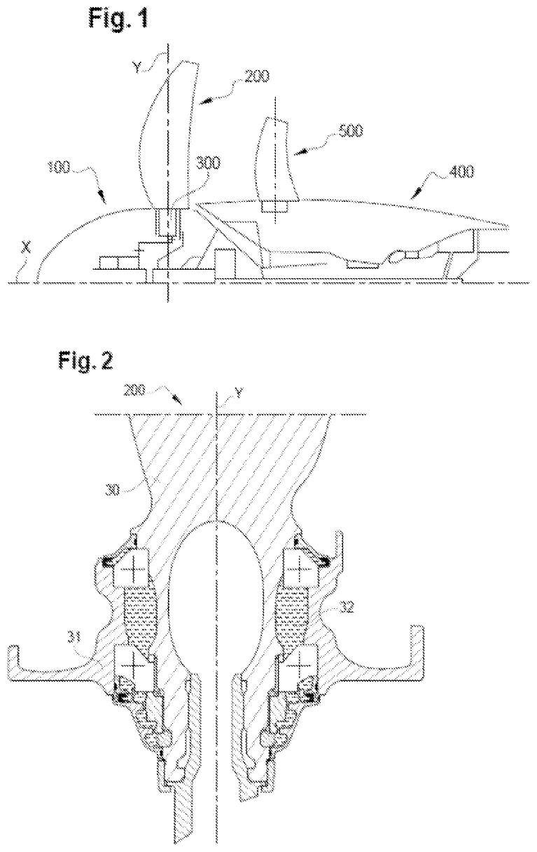

It should be noted that the invention applies in particular to aircraft turbomachines, and in particular to the turbomachines comprising at least one bladed propeller as shown in FIG. 1. Preferably, this propeller is non-faired.

This aircraft engine propeller rotor 100 rotates about an axis of rotation X. The propeller comprises a circle of blades 200 distributed about the axis of rotation X and each of the blades 200 comprises a root 300. The propeller rotor extends in front of a main body 400 of the engine, which can comprise a wheel 5 of variable-pitch blades rectifying the air flow, a combustion chamber, and turbines for expanding the gases.

The blades 200 are fastened at a trunnion 30 mounted movably in rotation about a central axis Y which is substantially perpendicular to the axis of rotation X of the aircraft engine. The blades 200 are guided in rotation about the axis Y by bearings arranged on either side of the trunnion 30.

The propeller rotor also comprises a hub 31, arranged around the trunnion, the hub 31 and the blade trunnion 30 defining a cavity 32 for circulation of a lubricant. It should be noted that this cavity also opens onto the bearings.

For their proper operation, the bearings must be in constant contact with lubricant. However, the expansion of the lubricant due to the rise in temperature during the operation of the turbomachine requires implementing a limited quantity of lubricant within the cavity, so as to not risk damaging the components of the propeller rotor. By limiting the quantity of lubricant, the expansion and the pressure exerted on the components of the propeller rotor are thus limited. However, the lubricant is no longer necessarily in continuous contact with the bearings if the volume of lubricant is less than the volume of the cavity.

Therefore, the rotor 100 also comprises a hydraulic compensation device 2 according to the invention which is mounted in the cavity 32.

Indeed, the smaller quantity of lubricant implemented is compensated for by the volume occupied in the cavities by the hydraulic compensation device. Thus, the lubricant remains in constant contact with the bearings.

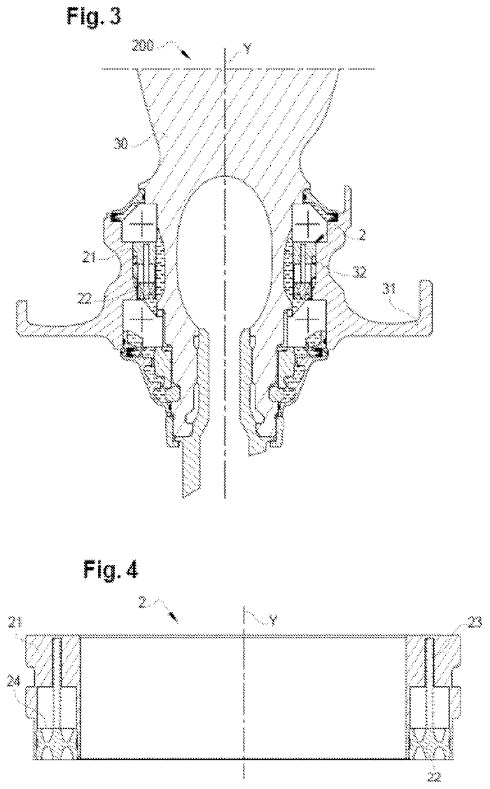

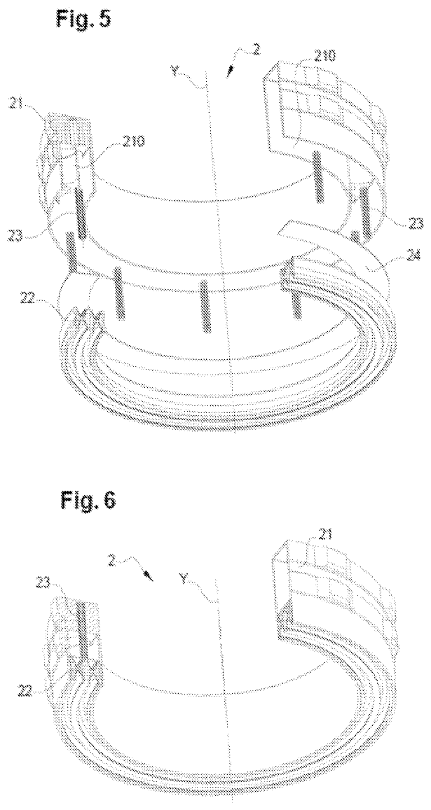

An embodiment of a hydraulic compensation device intended to be arranged in the cavity 32 for circulation of a lubricant is now presented in relation to FIGS. 3 to 6.

As illustrated, the compensation device comprises an annular body 21 and a piston 22 which is also annular. The annular body and the piston are arranged around the central axis Y.

This hydraulic compensation device 2 is fastened to the propeller rotor 100 via the annular body 21 fastened against an inner wall of the hub 31. The annular body can for example be mounted tightly by shrinking.

In the illustrated embodiment, the annular body 21 is made at least partially from a metal, a metal alloy, or a plastic.

For example, the annular body 21 can be made at least partially from titanium, stainless steel, or composites resistant to the temperatures to which the turbomachine can be subjected.

As for the piston 22, it is made at least partially from PTFE (virgin or filled) or an elastomer resistant to the temperatures to which the turbomachine can be subjected.

Thus, the piston 22 also acts as a seal.

The annular body 21 is hollow and has a U-shaped profile oriented towards the axis of the turbomachine X so that this annular body has a groove 210 forming a track in which the piston 22 is capable of sliding between at least an initial position and a retracted position.

More precisely, here, the piston 22 is capable of sliding in the annular body 21 along the central axis Y, that is to say perpendicular to the axis of the turbomachine.

This piston forms a seal here so that, during the sliding of the piston, the same quantity of air remains trapped in the groove 210 between the annular body and the piston.

In this embodiment, the initial position corresponds to a position when the turbomachine is not in operation, the piston thus being flush with the end of the annular body while axially stopped either by the elements forming the cavity 32, or via a stop ring (not shown). As for the retracted position, it corresponds to a position in which the piston is housed in the groove when the turbomachine is operating and the lubricant exerts a constant pressure on the components forming the cavity 32, on the rotor and stator side, corresponding to a pressure for an aircraft turbomachine at cruising speed.

This initial position can for example be adjusted according to a mounting need or a pre-stress defined during the design of the turbomachine.

So that the piston is returned towards the initial position when the pressure exerted by the lubricant decreases, the device comprises at least one return spring 23 provided between the annular body 21 and the piston 22.

This return spring 23 exerts a return force on the piston 22 so as to return it towards the initial position.

In this embodiment, the hydraulic compensation device comprises a plurality of return springs 23 angularly distributed between the annular body 21 and the piston 22.

According to an alternative not illustrated, the hydraulic compensation device can comprise a single circumferential spring.

In order to limit the deformations of the piston, in particular at the zones of contact with the return springs when the latter exert a return force, the hydraulic compensation device further comprises a bearing washer 24 arranged between the return spring(s) 23 and the piston 22.

In this embodiment, the bearing washer 24 is made at least partially from a metal, a metal alloy.

The bearing washer can in particular be made of stainless steel or titanium.

According to one alternative, the bearing washer could also be made at least partially from a preferably composite plastic.

What is claimed is:

1. A hydraulic compensation device intended to be arranged in a cavity for circulation of a lubricant of a bladed propeller rotor of a turbomachine having an axis, comprising an annular body and a piston, said annular body having a groove forming a track in which said piston is capable of sliding between at least an initial position and a retracted position.

2. The hydraulic compensation device according to claim 1, comprising at least one return spring arranged between said annular body and said piston and configured to exert a return force on said piston so as to return it towards said initial position.

3. The hydraulic compensation device according to claim 1, further comprising a bearing washer arranged between said at least one return spring and said piston.

4. The hydraulic compensation device according to claim 3, wherein said bearing washer is made at least partially from a metal or from a metal alloy, or from a preferably composite plastic.

5. The hydraulic compensation device according to claim 1, wherein said annular body is made at least partially from a metal, a metal alloy, or a plastic.

6. The hydraulic compensation device according to claim 1, wherein said piston is made at least partially from virgin PTFE, filled PTFE or an elastomer.

7. A bladed propeller rotor of a turbomachine having an axis, comprising a blade trunnion mobile in rotation about an axis perpendicular to said axis of the turbomachine, and a hub arranged around said trunnion, said hub and said blade trunnion defining a cavity for circulation of a lubricant, wherein said rotor further comprises the hydraulic compensation device according to claim 1, said hydraulic compensation device being mounted in said cavity.

8. The propellor rotor according to claim 7, wherein said piston is capable of sliding in said annular body along said axis.

9. The propellor rotor according to claim 7, wherein said hydraulic compensation device is fastened to said propeller rotor via said annular body fastened against an inner wall of said hub.

10. A bladed propeller, comprising the rotor according to claim 7.

11. An aircraft turbomachine, comprising at least one bladed propeller according to claim 10.
